(19) United States
(12) Patent Application Publication
(10) Pub. No.: US 2021/0023955 A1
(43) Pub. Date: Jan. 28, 2021

(54) PARKING VEHICLE, METHOD FOR PARKING AN ELECTRIC VEHICLE AND FOR CHARGING THE BATTERY OF THE ELECTRIC VEHICLE, AND PARKING SPACE SYSTEM

(71) Applicant: ZF Friedrichshafen AG, Friedrichshafen (DE)

(72) Inventors: Marc SCHIEß, Hohenfels (DE); Andreas KNOLL, Ravensburg (DE); Jens HEIMANN, Stetten (DE); Nils MÜHL, Friedrichshafen (DE)

(21) Appl. No.: 16/640,817

(22) PCT Filed: Jul. 20, 2018
(86) PCT No.: PCT/EP2018/069723

§ 371 Date: Feb. 21, 2020

(30) Foreign Application Priority Data
Aug. 22, 2017 (DE) 10 2017 214 647.8

(51) Int. Cl. B60L 53/36; B60L 53/18; E04H 6/12; H02J 7/04; H02J 50/90; H02J 7/00; B60W 30/06; B60W 60/00

(52) U.S. Cl. CPC B60L 53/36; B60L 53/18; E04H 6/12; H02J 7/04; B60L 2240/70; H02J 7/0047; H02J 7/0045; B60W 30/06; B60W 60/0025; H02J 50/90

(57) ABSTRACT

A parking vehicle for the transport and parking of an electric vehicle. The parking vehicle has a platform on which the electric vehicle can be parked and has a charging system to charge the electric vehicle. The charging system has an electric energy storage which is connected to a contact system. The charging system is connected to the platform. The parking vehicle is connected to an electric energy supply which is connected to the charging system. The parking vehicle has a charging regulator connected to the charging system. The parking vehicle has a communications device which transmits and receives the data of an external system. The parking vehicle has a control device connected with the communications device. Movement of the parking vehicle is controlled in longitudinal and transverse directions by the control device.

This application is a National Stage completion of PCT/EP2018/069723 filed Jul. 20, 2018, which claims priority from German patent application serial no. 10 2017 214 647.8 filed Aug. 22, 2017.

### FIELD OF THE INVENTION

The present invention concerns a parking vehicle for conveying and parking an electric vehicle, a method for parking an electric vehicle and for charging a battery of the electric vehicle by means of a parking vehicle and a parking space system.

### BACKGROUND OF THE INVENTION

Vehicles, which drive purely electrically, are becoming more and more popular. The batteries of these vehicles have to be charged which takes some time. Hereby, the electric vehicle is connected to a charging station. As soon as the electric vehicle is fully charged, the vehicle can leave the charging station. This is usually not often the case as it, for instance, remains connected overnight. Thus, the charging station is blocked for other electric vehicles. In addition, there exists the problem of limited parking space in cities. Public parking facilities or parking lots are often too tight and not used effectively. Usually, there are often only a few charging stations for electric vehicles.

Through DE 10 2013 207 906 A1, a device is known for positioning a vehicle above a primary coil for inductively charging a rechargeable battery of a vehicle. Hereby, the vehicle is guided by means of cameras and a control device in such a way that it stops above the primary coil for the inductive charging.

### SUMMARY OF THE INVENTION

Starting from the state-of-the-art, the present invention is based on the objective of proposing an improved possibility for parking and charging of an electric vehicle. Hereby, a parking place with an electric energy supply shall not be blocked by an already charged electric vehicle.

The present invention proposes, based on the previously mentioned objective, a parking vehicle for the transport and parking of an electric vehicle in accordance with the independent claim(s), a method for parking an electric vehicle and for charging the battery of the electric vehicle by means of the parking vehicle in accordance with the independent claim(s) and a parking place system in accordance with the independent claim(s). Additional preferable embodiments and further designs emerge from the dependent claims.

A parking vehicle for the transport and parking of an electric vehicle has a platform on which the electric vehicle can be parked. The parking vehicle has a charging system for charging the electric vehicle, whereby the charging system has a storage for the electric energy and a contact system. The contact system is connected to the storage. The charging system is connected to the platform. The parking vehicle has a connector to connect the parking vehicle to an electric energy supply, whereby the connector is connected to the charging system. The parking vehicle has a charging regulator which is connected to the charging system. The parking vehicle has a communications device which is designed for transmitting and receiving data from at least one external system. The parking vehicle has a control device which is connected to the communications device. By means of the control device, the parking vehicle can be controlled in the longitudinal direction and the transverse direction.

In addition, the parking vehicle has also an electric drive train which is connected to the storage of the charging system. Thus, the electric drive train can be supplied with energy by means of the storage or can supply it with energy. The storage can, for instance, have a battery or several batteries. The storage of the charging system serves to supply the parking vehicle, as well as the electric vehicle, with electric energy. Furthermore, the parking vehicle has three or more wheels or a chain drive for movement. These wheels or the chain drive are electrically driven by means of the electric drive train. The wheels or the drive chain are designed in such a way so that the parking vehicle can maneuver without any problems, meaning forward, backwards, as well as around curves.

The electric vehicle can be for instance a PKW (passenger car), NKW (truck), e-bike, Pedelec, e-scooter, e-motorbike, or a similar electric vehicle. The electric vehicle has hereby one or several devices through which it can be connected to the charging system of the charging vehicle, for instance a power outlet and/or a device through which inductive charging is made possible. By means of a contact system, electric energy can be passed from the storage of the charging system to the electric vehicle.

The platform serves to place an electric vehicle on it. Meaning that the platform is designed as a way that the electric vehicle can drive on it. Hereby, the platform can have for instance a ramp. Alternatively, the platform can also be positioned in a pit of a parking garage or parking lot floor, so that the electric vehicle can drive at ground level onto the platform. The platform can also be lifted out of the pit or moved out of it. The platform is designed with regard to its dimensions and stability in such a way that it can carry and transport the electric vehicle. The wheels or the chain drive are movably mounted on the platform.

The charging system is connected to the platform. For instance, the charging system can be integrated with the platform. For instance, the storage of the charging system can be arranged within the platform, so that it does not protrude from the platform, or it can be connected at the outer contour of the platform. For instance, the contact system can be integrated into the platform, meaning inside of the platform, so that it does not protrude from the platform. The arrangement of the contact system on the platform and the connection of the contact system with the platform are dependent on the design of the contact system. For instance, the contact system can be designed as an inductive charging device, for instance as inductive coil, or as a charging cable, or as a combination of both.

The parking vehicle has a connection for connecting the parking vehicle to an energy supply, whereby the connection is connected to the charging system. Alternatively hereto, the connection can be designed as a charging cable or as a plug system. In any case, the connection serves to connect the parking vehicle to an electric energy supply and through it provide the parking vehicle with electric energy. This means that electric energy can be passed through the connection of the parking vehicle to the storage of the charging system of the parking vehicle. The electric energy is temporarily kept in the storage.

The parking vehicle has a charging regulator which is connected with the charging system. The charging regulator monitors how much electric energy is provided by the charging system for the electric vehicle which needs to be charged. In addition, the charging regulator can monitor how much electric energy is loaded into the charging system of the parking vehicle. Thus, the charging regulator monitors a charging state of the electric vehicle to be charged.

The parking vehicle has a communication device which is designed for transmitting and receiving data from at least one external system. The communication device uses for the transmission and reception, preferably a broadcasting standard. The at least one external system can be for instance a central device which monitors the parking vehicle. For instance, the central device can monitor a parking garage or parking lot where the parking vehicle is used. For instance, the at least one external system can be the electric vehicle which needs to be charged, several electric vehicles, an additional parking vehicle, or similar. Obviously, the parking vehicle can exchange or communicate data by means of the communication device with more than one external system. By means of the communication device, control instructions, positioning data, charging state data, can for instance be transmitted or received.

The parking vehicle has a control device which is connected to the communications device. By means of the control device, the parking vehicle can be controlled in a longitudinal direction and a transversal direction. This means that the control device can control the wheels or the chain drive of the parking vehicle and can adjust the steering angle. Furthermore, the control device can control the electric drive train and can influence the acceleration of the parking vehicle. In addition, the control device can be connected to the charging system and, for example, control the charging system, so that the control device can initiate a charging process when an electric vehicle is parked on the platform of the parking vehicle. Alternatively, the charging process can be initiated by the external system when the electric vehicle is parked on the platform of the parking vehicle. The data are hereby received by means of the communication device.

If the parking vehicle is now used in a parking garage or in a parking lot, the electric vehicle which has to be charged is driven on top of the platform of the parking vehicle and parked there. Hereby, the parking vehicle is preferably positioned in the parking garage or at the parking lot in such a way that the electric vehicle can easily locate the parking vehicle and drive on to it. The contact system of the charging system will be connected to the electric vehicle. This can take place either automatically or manually. Thereafter, the parking vehicle receives from a central device, by means of the communication device the position data of a charging location with the parking garage or the parking lot. The charging station is designed in such a way that it has an electric energy supply to which the parking vehicle can be connected to by means of its connection. The parking vehicle is guided along a drive route to the charging location.

The parking vehicle drives, in other words, automatically or autonomously to the charging station. For instance, the drive route can be specified by the central device, or the parking vehicle can find and define its route by itself. Hereby, autonomous driving means that the parking vehicle executes its own drive route, through detecting and monitoring its surroundings by means of sensors and, based on the sensor data, execute its drive route. Automated driving, to the contrary, can be compared to remote-controlled driving. Hereby, the parking vehicle receives by means of the communication device from, for instance, the central device a predetermined drive route and it drives along that route. In addition, the central device can transmit control instructions to the parking vehicle and can trigger the control device of the parking vehicle.

When the parking vehicle has reached the charging location, it is positioned by the control device in such a way that the connection of the parking vehicle connects itself to the electric energy supply. This connection is reversible. If the connection is established to the electric energy supply, electric energy is supplied to the storage of the charging system and temporarily stored there. In addition, the charging process is initiated and the electric vehicle to be charged is supplied with electric energy by means of the contact system. Thus, the battery of the electric vehicle is charged. The charging process is monitored by means of a charging regulator. If the battery of the electric vehicle has reached a predetermined charging state, which is recognized by the charging regulator, the charging process will be terminated. The electric vehicle can be separated from the contact system of the charging system of the parking vehicle, or alternatively, it can remain connected to it. Thereafter, the parking vehicle including the electric vehicle parked on it is moved away from the charging location. For instance, the central device can transmit additional position data for the parking vehicle by means of the communication device, to which the parking vehicle is moved. At this position, an electric energy supply does not need to be present. The parking vehicle is brought along a drive route to this additional position by means of the control device. Hereby, the parking vehicle drives automatically or autonomously.

An advantage of the parking vehicle presented here is that a parking process no longer has to be carried out by the vehicle user. The search for a parking place and complicated maneuvering are no longer necessary. Also, the user of the electric vehicle does not need to search for a parking spot with an electrical energy supply. In addition, after the charging process has ended, the electric vehicle does not block the charging location or the electric energy supply for additional electric vehicles which also need to be charged. Also, less charging locations can be provided in parking garages or parking lots. Also, the available parking space can be used more efficiently.

In one embodiment, the contact system of the charging system is designed as a charging cable which is connected to the storage of the charging system. The charging cable is a conventional charging cable for electric vehicles, which is used at common charging locations or charging stations for electric vehicles. The charging cable can, for instance, be adapted to the various customary plug standards. For instance, the contact system can be designed with different charging cables, whereby each charging cable has a different plug in accordance with a plug standard.

The charging cable is designed in such a way that it can be manually connected to the electric vehicle. This connection is reversible. The charging cable is connected to the storage of the charging system of the parking vehicle in a wired manner. Thus, the electric energy of the storage can be passed to the electric vehicle to be charged by means of the charging cable. It is advantageous that the charging cable can be manufactured inexpensively and in a simple manner. In addition, the charging cable is compatible with different electric vehicles. This makes it possible to use the parking vehicle in a public parking garage or a public parking lot.

The charging cable is designed in an additional embodiment as an automated charging cable. The charging cable is designed in such a way that it can automatically connect to the electric vehicle. This connection is reversible. For instance, the automated charging cable can automatically connect to the electric vehicle as soon as the electric vehicle is parked on the platform of the parking vehicle. The advantage here is that the connection can be established without assistance by the vehicle user of the electric vehicle or by another person.

The contact system of the charging system is in an additional embodiment designed as an inductive charging system which is integrated into the platform. The inductive charging device is for instance an inductive coil. It is positioned within the platform so that inductive charging of the electric vehicle can take place. The parking vehicle can for instance have the inductive charging station as well as the charging cable. Thus, two alternatives are present to connect the electric vehicle with the storage of the charging system of the parking vehicle, and to charge the battery of the electric vehicle.

In an additional embodiment, the parking vehicle has a sensor system which determines surrounding data, whereby the sensor system is connected to the control device, and the parking vehicle can be controlled, based on these surrounding data, by means of the control device. The sensor system can be designed for instance as a radar system, as LIDAR system, as a camera system, or as a combination of these systems. The surrounding data are hereby data which concern the entire surroundings of the parking vehicle. For instance, surrounding data can contain data about obstacles, slopes, roadway inconsistencies, road condition, road surface, or similar. The sensor system can have an evaluation device which evaluates the captured data. Alternatively, the captured surrounding data can be evaluated by the control device.

The evaluated surrounding data is used by the control device to control the parking vehicle along its drive route. The parking vehicle can therefore find its drive route by itself. For instance, the communications device can inform the parking vehicle about the position data regarding the charging station. Thereafter, the parking vehicle determines a drive route based on the evaluated surrounding data. The parking vehicle and therefore react to suddenly appearing obstacles and, for instance, avoid the obstacles or slow down.

In a method for parking an electric vehicle and for charging a battery of an electric vehicle by means of the parking vehicle, which has already been described above, the electric vehicle is parked on the platform of the parking vehicle. The electric vehicle will be driven by the vehicle user onto the platform and safely parked. The electric vehicle will then be connected to the contact system. This means that electric energy can be passed from the contact system to the electric vehicle. This connecting can take place either automatically or manually. If the contact system is designed as an automated charging cable or as an inductive charging device, the connecting takes place automatically. If the contact system is designed as a common charging cable, the connecting takes place manually. This means that the vehicle user inserts the charging cable into the electric vehicle.

Position data are transmitted from an external system to the parking vehicle, which are received by the communication device, whereby the position data contain the position of an empty parking space with an electric energy supply. Hereby, the external system is a central device which monitors the parking garage or the parking lot in which or where the parking vehicle is used. The position data indicate therefore the position where a charging place is located. Then, the vehicle is guided by the control device to this position. The control device guides hereby the vehicle along its drive route. This drive route can be for instance predetermined by the external system, or it can be calculated by the parking vehicle itself, for instance from the surrounding data. The control device controls the wheels or the chain drive, as well as the drive train of the parking vehicle. Thus, the control device can influence the steering angle and the acceleration of the parking vehicle.

If the parking vehicle has reached the predetermined position, it parks in this position and connects itself by means of its connection to the electric energy supply, so that the electric energy supply provides the storage of the charging system with energy. The connection hereby takes place automatically. For instance the control device and position the parking vehicle in a way that the connection is performed with the electric energy supply by itself, for instance an insertion of the connection. As soon as the parking vehicle is connected, electrical energy can be passed on from the electrical energy supply to the storage system of the charging system and stored there temporarily.

The charging system supplies the battery of the electric vehicle, by means of the contact system, with electric energy and charges it. Hereby, the electric energy is passed from the storage of the charging system, via the contact system, to the battery of the electric vehicle. This can take place either without contact or wired. The charging procedure is regulated by the charging regulator and monitored. The charging of the battery of the electric vehicle will be terminated when the charging regulator recognizes a predetermined charging state of the battery of the electric vehicle. This predetermined charging state can either relate to a completely charged battery, or a partially charged battery. For instance, the battery can be charged to ⅔, ¾, or ½. When the charging procedure is finished, electric energy is no longer passed on to the battery of the electric vehicle.

In an embodiment, the connecting of the electric vehicle with the contact system is automated. That is possible when the contact system is designed as an automated charging cable or as an inductive charging device.

In an additional embodiment, the supply of electric energy to the storage of the charging system is accomplished without contact. This is possible when the contact system is designed as inductive charging device.

In an additional embodiment, the supply of electric energy to the storage of the charging system takes place by means of a plug connection. This is possible when the contact system is designed as a charging cable.

In an additional embodiment, the termination of the charging of the battery of the electric vehicle is transmitted by means of the communication device to the external system. For instance, the charging regulator which monitors the charging process can transmit a signal to the control device that the charging process is finished. The control device transmits this information to the external system by means of the communication device. Alternatively, the charging regulator can transmit its signal directly to the external system by means of the communication device.

In a further embodiment, additional positioning data is transmitted, after completion of the charging of the battery of the electric vehicle, by the external system to the parking vehicle, which is received by the communication device. The additional positioning data contain the position of an empty parking space with no electric energy supply. The transmission and reception of this additional positioning data takes place in the same manner as with the transmission and reception of the positioning data which included the position of an empty parking space with the electric energy supply. The transmission of additional positioning data by the external system is triggered when it has received the information that the charging process has been completed.

The parking vehicle is thereafter guided to this position by the control device. The parking vehicle is again guided along a drive route which can be predetermined by the central device or can be determined by the parking vehicle itself. Thus, the parking vehicle drives autonomously or automatically. The parking vehicle parks itself in this next position. The electric vehicle is hereby located on the parking vehicle on the parking space without electric energy supply and does not block the parking space with the electric energy supply. Thus, another electric vehicle can be brought to the parking space with an electric energy supply by another parking vehicle. The battery of one of the electric vehicles can here be charged.

The already charged vehicle therefore makes room for another electric vehicle which needs to be charged. Thus, the parking area can be used more efficiently.

A parking place system for parking several electric vehicles has at least two parking vehicles which have already been described in the previous description, whereby these parking vehicles execute the method which has already been described in the previous description. The parking place system can be applied either in a parking garage or a parking lot. The parking place system has an external system which is designed as a central device which is responsible for the monitoring of the parking lot or the parking garage. Hereby, all the position data of all parking places with or without energy supply are known. The external system can organize all parking vehicles by means of an algorithm and positioning them from one parking place to another parking place.

### BRIEF DESCRIPTION OF THE DRAWINGS

Based on the following, explained drawings, the different embodiments and details of the invention are described. These show:

FIG. 1 a schematic presentation of a parking vehicle based on an embodiment, and

FIG. 2 a schematic presentation of a parking place system based on an embodiment.

### DETAILED DESCRIPTION OF THE PREFERRED EMBODIMENTS

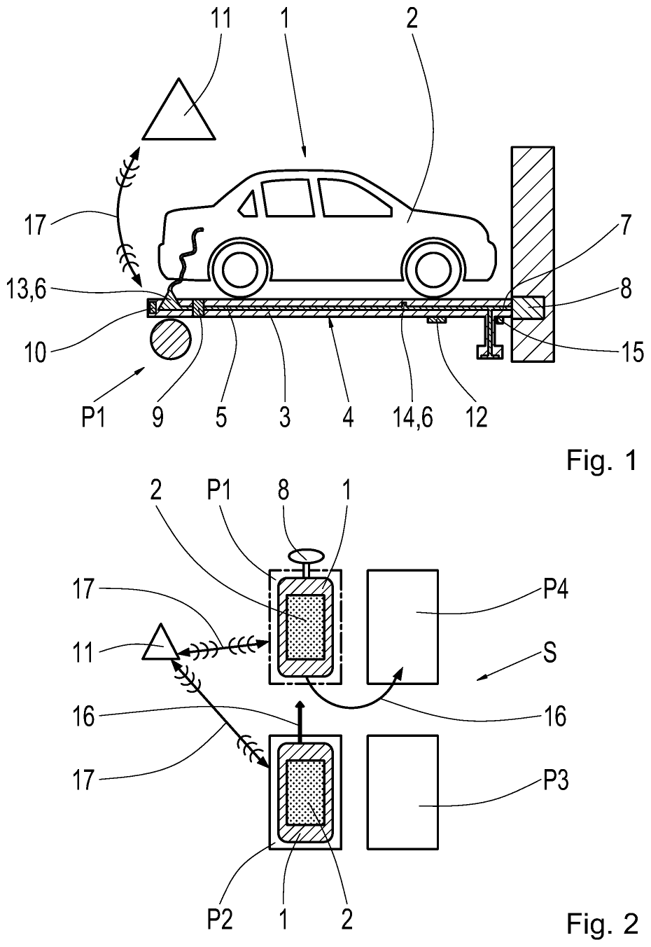

FIG. 1 shows a schematic presentation of a parking vehicle 1 based one embodiment. Presented is the parking vehicle 1 on which an electric vehicle 2 is parked. The parking vehicle 1 is located with the electric vehicle 2 on the parking place P1 with an energy supply 8. Also, an external system 11 is shown, which is a central device, for instance, for parking space monitoring.

The parking vehicle 1 has a charging system 4, whereby the charging system 4 has a storage 5 for electric energy and a contact system 6. The contact system 6 is connected to the storage 5. Also, the parking vehicle 1 has a connection 7 via which the parking vehicle 1 is connected to the energy supply 8. Furthermore, the parking vehicle 1 has a control device 12, a communication device 10, a charging regulator 9, and a sensor system 15. The charging regulator 9 is connected to the charging system 4. The control device 12 is connected to the communication device 10 and the sensor system 15. The parking vehicle 1 has also an electric drive train which is here not presented. In addition, the parking vehicle 1 has wheels which are here presented just schematically. The control device 12 is connected to the electric drive train and the wheels. The electric drive train can control the wheels and the electric drive train and can, for instance, set the wheels at a steering angle or influence the acceleration of the parking vehicle 1.

The parking vehicle 1 has a platform 3. The platform 3 is designed in such a way that the electric vehicle 2 can stop on this platform and stay on it. Thus, the electric vehicle 2 can park on the platform 3. The electric vehicle 2 can be transported by the parking vehicle 1 without having to apply its own drive power.

The contact system 6 of the charging system 4 is designed as a charging cable 13 and as a inductive charging device 14. The electric vehicle 2 is connected to the charging system 4 of the parking vehicle 1 by means of the charging cable 13. Thus, the electric energy of the charging system 4 can be passed via the contact system 6, which is designed as a charging cable 13, to the battery of the electric vehicle 2. This electric energy is provided by the electric energy supply 8. By means of the connection 7, through which the parking vehicle 1 is connected to the energy supply 8, the electric energy is passed to the storage 5 of the charging system 4 and is temporarily stored there. The present electric energy in the storage 5 serves on one hand for charging of the electric vehicle 2, and on the other hand for operating the parking vehicle 1.

Charging of the battery of the electric vehicle 2 is controlled and monitored by means of the charging regulator 9. For this purpose, the charging regulator 9 is connected to the charging system 4. The charging regulator 9 is integrated into the platform 3 of the parking vehicle 1. The charging regulator 9 controls how much electric energy is passed from the storage 5 of the charging system 4 to the electric vehicle 2.

The communication device 10 of the parking vehicle 1 serves for the exchange of data between the parking vehicle 1 and the external system 11. This exchange of data 17 is made clear through an arrow. The external system 11 which is designed as central system, can transmit positioning data to the parking vehicle 1. The positioning data can include, for instance, the position of the parking space P1 which has the electric energy supply 8. By means of the communication system 10, the parking vehicle 1 informs the external system 11 when a charging process of the electric vehicle 2 has been successfully completed. This is, for instance, the case when the battery of the electric vehicle is fully charged. If the charging process is completed, the external system 11 can transmit additional positioning data to the parking vehicle 1, which it receives by means of its communication device 10. The parking vehicle 1 can then be moved from the parking space P1 with the electric energy supply 8 to another parking space, at which no electric energy supply is present. Hereby, the parking vehicle 1 is disconnected from the electric energy supply 8 of the parking space P1.

The parking vehicle 1 can drive automatically or autonomously along its drive route. For this purpose, the parking vehicle 1 has the sensor system 15 and the control device 12. The sensor system 15 can be, for instance, a radar system, a LIDAR system, a camera system, or a combination of these systems. By means of the sensor system 15, surrounding data of the parking vehicle 1 is captured and analyzed. The analysis of the surrounding data can alternatively take place via the control unit 12. Based on the surrounding data, the control unit 12 can guide the parking vehicle along the drive route. For instance, the external system 11 can predetermine a position to which the parking vehicle 1 should drive to. The parking vehicle 1 alone can find its position by means of the sensor system 15. Alternatively or in addition hereto, the external system 11 can predetermine the entire drive route. This drive route pre-determination is sent by the data exchange 17 to the parking vehicle 1 and received by the communication device 10.

FIG. 2 shows a schematic presentation of a parking place system S in accordance with an embodiment. Four parking spaces P1, P2, P3, P4, are shown. In addition, two parking vehicles 1 are shown, on each is an electric vehicle 2 positioned. A first parking place P1 has an electric energy supply 8. A first parking vehicle 1 is connected to the electric energy supply 8. The electric vehicle 2 is provided with electric energy through the first parking vehicle 1 and the battery of the electric vehicle is charged. The shown parking vehicles 1 and electric vehicles 2, as well as the external system 11, have each the same design as already described in FIG. 1.

A second electric vehicle 2 is located on a second parking vehicle 1. This second parking vehicle 1 is located on the parking place P2. This one does not have an electric energy supply 8. Thus, the electric vehicle 2, which is located at the parking place P2 and on the second parking vehicle 1, cannot be provided with electric energy.

Both parking vehicles 1 communicate with the external system 11. A data exchange 17 takes place. When the battery of the electric vehicle 2, which is located on the first parking vehicle 1, shows a predetermined charge state, i.e. fully charged, a signal is sent to the external system 11. The charging state is determined by the charging regulator which is shown in FIG. 1. The external system 11 then sends an additional position to the parking vehicle 1, to which the first parking vehicle 1 should proceed. In this case, it is the position of the fourth parking space P4. The movement of the first parking vehicle 1 is marked here by means of an arrow in the moving direction 16. This means that as soon as the charging process of the electric vehicle 2, which is located on the first parking vehicle 1, is completed, the first parking vehicle 1 is moved along a drive route, by means of its control device, from the first parking space P1 to the fourth parking space P4. Thus, the electric energy supply 8, which is located at the parking space P1, is made available for the electric vehicle 2 which is on the second parking vehicle 1.

The second parking vehicle 1, on which the electric vehicle 2 is located and which has still to be charged, receives positioning data of the parking place P1 from the external system 11. The second parking vehicle 1 is moved, by means of its control device, along a drive route which is marked by the moving direction arrow 16, from the second parking place P2 to the first parking place P1. The second parking vehicle 1 connects itself, by means of its connection with the electric energy supply 8. Electric energy is passed by the electric energy supply 8 into the storage of the second parking vehicle 1, which is passed by the contact system 6 to the electric vehicle 2. Thus, the battery of the electric vehicle 2 which is located on the second parking vehicle 1, is charged. As soon as the charging process of the electric vehicle 2 which is located on the parking vehicle 1 is finished, a signal is again transmitted to the external system 11. The second parking vehicle 1 is then moved from the first parking place P1 to an empty parking place, on which no electric energy supply 8 is provided, meaning on the second parking place P2 or a third parking place P3.

Thus, the first parking place P1, which has the electric energy supply 8, can be used by several electric vehicles 2. These are transported, by means of the parking vehicles 1, in each case to the parking place P1 with the electric energy supply 8 and then move away when the charging process is finished. Thus, it is not necessary to provide at each parking place P1, P2, P3, P4 an electric energy supply. Thus, the parking space can be used more efficiently.

The presented embodiments are here selected examples. For instance, the parking vehicle can also have a chain drive instead of wheels.

### REFERENCE CHARACTERS

1 Parking Vehicle
2 Electric Vehicle
3 Platform
4 Charging System
5 Storage
6 Contact System
7 Connection
8 Electric Energy Supply
9 Charging Regulator
10 Communications Device
11 External System
12 Control Device
13 Charging Cable
14 Induction Charging Device
15 Sensor System
16 Movement Direction
17 Data Exchange
P1 Parking Space
P2 Parking Space
P3 Parking Space
P4 Parking Space
S Parking Space System

1-12. (canceled)

13. A parking vehicle (1) for transporting and parking of an electric vehicle (2), the parking vehicle comprising:
a platform (3) on which the electric vehicle (2) can be parked,
a charging system (4) for charging the electric vehicle (2), the charging system (4) having a storage (5) for electric energy and having a contact system (6), the contact system (6) being connected to the storage (5), and the charging system (4) being connected to the platform (3),
a connection (7) to connect the parking vehicle (1) to an electric energy supply (8), and the connection (7) being connected to the charging system (4),
a charging regulator (9) being connected to the charging system (4),
a communications device (10) designed for transmitting and receiving data of at least one external system (11), and
a control device (12) connected to the communications device (10), and the parking vehicle (1) being controllable in a longitudinal direction and a transverse direction by the controlling device (12).

14. The parking vehicle (1) according to claim 13, wherein the contact system (6) of the charging system (4) is designed as a loading cable (13) which is connected to the storage (5) of the charging system (4).

15. The parking vehicle (1) according to claim 14, wherein the loading cable (13) is designed as an automated charging cable.

16. The parking vehicle (1) according to claim 13, wherein the contact system (6) of the loading system (4) is designed as an inductive charging device (14) which is integrated into the platform (3).

17. The parking vehicle (1) according to claim 13, further comprising a sensor system (15) which detects surrounding data, the sensor system (15) is connected to the control device (12), and the parking vehicle (1) is controllable by the control device (12) based on the detected surrounding data.

18. A method for parking an electric vehicle (2) and for charging a battery of the electric vehicle (2) by a parking vehicle (1) having a platform (3) on which the electric vehicle (2) can be parked, a charging system (4) for charging the electric vehicle (2), the charging system (4) has a storage (5) for electric energy and has a contact system (6), the contact system (6) is connected to the storage (5), and the charging system (4) is connected to the platform (3), a connection (7) for connecting the parking vehicle (1) to an electric energy supply (8), and the connection (7) is connected to the charging system (4), a charging regulator (9) which is connected to the charging system (4), a communications device (10) which is designed for transmitting and receiving data of at least one external system (11), and a control device (12) which is connected to the communications device (10), the parking vehicle (1) is controllable in a longitudinal direction and a transverse direction by the controlling device (12), the method comprising:
parking the electric vehicle (2) on the platform (3) of the parking vehicle (1),
connecting the electric vehicle (2) to the contact system (6),
transmitting the positioning data from the external system (11) to the parking vehicle (1), the positioning data is received by the communications device (10), and the positioning data comprising the position of an empty parking place (P1) which has an electric energy supply (8),
guiding the parking vehicle (1), via the control device (12), to the position of the empty parking place,
parking the parking vehicle (1) in the empty parking place and connecting the parking vehicle with the electric energy supply (8) by the connection (7) such that the electric energy supply (8) supplies the storage (5) of the charging system (4) with the electric energy,
supplying energy to the charging system (4) and charging the battery of the electric vehicle (2) with the energy with the contact system (6) of the parking vehicle (1),
controlling and monitoring charging of the battery of the electric vehicle (2) with the charging regulator (9), and
terminating the charging of the battery of the electric vehicle (2) when the charging regulator (9) recognizes a predetermined charging condition of the battery of the electric vehicle (2).

19. The method according to claim 18, further comprising automatically connecting the electric vehicle (2) with the contact system (6).

20. The method according to claim 18, further comprising supplying the storage (5) of the charging system (4) with electric energy in a contactless manner.

21. The method according to claim 18, further comprising supplying the storage (5) of the charging system (4) with the electric energy by a plug connection.

22. The method according to claim 18, further comprising transmitting termination of the charging of the battery of the electric vehicle (2) by the communications device (10) to the external system (11).

23. The method according to claim 22, further comprising
transmitting, after the termination of the charging of the battery of the electric vehicle (2), additional position data by the external system (11) to the parking vehicle (1), and receiving the additional position data by the communications device (10), and the positioning data containing a position of another empty parking space (P2) without any electric energy supply (8),
guiding the parking vehicle (1) to the another position via the control device (12), and
positioning the parking vehicle (1) at the another position.

24. A parking space system for parking a plurality of electric vehicles (2), the parking place system (S) having at least two parking vehicles (1) for charging batteries of the plurality of electric vehicles (2),
the at least two parking vehicles (1) each having a platform (3) on which one of the plurality of electric vehicles (2) can be parked, respectively,
a charging system (4) for respective charging the electric vehicle (2), the charging system (4) having a storage (5) for electric energy and having a contact system (6), the contact system (6) being connected to the storage (5), and the charging system (4) being connected to the platform (3),
a connection (7) for connecting the respective at least two parking vehicles (1) to an electric energy supply (8), and the connection (7) being connected to the charging system (4),
a charging regulator (9) connected to the charging system (4),
a communications device (10) designed for transmitting and receiving data of at least one external system (11), and
a control device (12) connected to the communications device (10), and the at least two parking vehicles (1) are each controllable in a longitudinal direction and a transverse direction by the respective controlling device (12).
